(19) United States
(12) Patent Application Publication
(10) Pub. No.: US 2010/0263810 A1
(43) Pub. Date: Oct. 21, 2010

(54) Hinged Window Screen

(76) Inventor: Jon Goldstein, Scarsdale, NY (US)

Correspondence Address: MELVIN I. STOLTZ, ESQ., 51 CHERRY STREET, MILFORD, CT, 06460, US

(21) Appl. No.: 12/083,156

(22) PCT Filed: Oct. 10, 2006
(86) PCT No.: PCT/US06/39826

§ 371 Date: Apr. 3, 2008

Related U.S. Application Data
(60) Provisional application No. 60/725,588, filed on Oct. 11, 2005.

(51) Int. Cl. A47G 5/00; B23P 19/00

(52) U.S. Cl. 160/368.1; 160/371; 160/381; 29/700

(57) ABSTRACT

The window screen assembly of the present invention comprises a screen member affixed to a screen frame wherein the screen frame has at least one pair of opposing hinges. One such hinge is centrally located on one side of the screen frame and one centrally located on the opposite side of the screen frame such that both the screen frame and the screen itself fold upon rotation or pivoting of the hinges. The hinges can be located either on the horizontally disposed members of the screen frame or the vertical members of the screen frame, or both. In a preferred embodiment, the assembly further includes a plurality of retaining clips. The retaining clips are attachable to the window frame, such as with a screw, and the hinges slide into or are snapped into the retaining clip so as to hold the assembly in place while still allowing rotation of the hinges. The hinges are positioned to form an inwardly directed V-shape upon folding, thereby providing easy access to open and close outward opening (casement) type windows.

### TECHNICAL FIELD

This invention relates to window screen assemblies and more particularly to a hinged window screen assembly.

### BACKGROUND ART

A great variety of window screens for allowing air to pass into a room while preventing insects from entering has been proposed and put into use. Typical types of prior art window screens can be found with reference to U.S. Pat. Nos. 6,505,669, 3,948,308, 2,269,817 and in patent applications GB2196677, WO8200850, EP0811317 and EP1048818. In general, the prior art discloses a screen material mounted on a rigid frame or being capable of being rolled up in a manner similar to a window shade. In some instances the rigid frame type window screen may be hinged to the frame of the window in which it is mounted so that it may swing out or up or alternatively, adjacent screens may be hinged to each other so as to provide a bi-fold structure. Some screens merely fit into the window opening while others include a mounting device affixed to the frame of the window that is adapted to retain the window screen.

However, there still exists a need for an inexpensive, easy to mount and remove window screen that is not only useful in typical single or double hung windows, but also in casement windows of the type often found in Europe which do not have a crank handle for opening or closing the window

### SUMMARY OF THE INVENTION

The window screen assembly of the present invention comprises a screen member affixed to a screen frame wherein the screen frame has at least one pair of opposing hinges. One such hinge is on one side of the screen frame and one on the opposite side of the screen frame such that both the screen frame and the screen itself fold upon rotation or pivoting of the hinges. When the screen frame has only one pair of hinges the hinges are preferably located at or near the center of those screen frame members having the hinges. Alternatively, the screen frame may have a plurality of hinge pairs, so that it is foldable at several places. The hinges can be located either on the horizontally disposed members of the screen frame or the vertical members of the screen frame, or both. In a preferred embodiment, the assembly further includes a plurality of retaining clips. The retaining clips are attachable to the window frame, such as with a screw, and the screen frame slides into or is snapped into the retaining clip so as to hold the assembly in place while still allowing rotation of the hinges. When the hinges are positioned to form an inwardly directed V-shape upon folding, easy access is provided to open and close outward opening (casement) type windows.

### THE DRAWINGS

FIG. 1 is a front view of a window screen assembly according to one embodiment of the invention, fitted to a window frame;

FIG. 2 is a front plan view of the insect screen assembly shown in FIG. 1, as seen from the inside of the window, in an open position with the frame of the insect screen folded in a V-shape, thereby permitting access to open and close the window;

FIGS. 3a and 3b are front and side elevational views respectively, of a preferred screen frame;

FIGS. 4a and 4b are front and side views of a corner piece of the frame, which interconnects to the frame members by inserting it therein;

FIG. 5 is a three dimensional view of a hinge which interconnects to the frame members and allows the frame to fold around the hinge axis;

FIG. 6 is a three dimensional view of a hinge clip used for securing the frame assembly to the window frame;

FIG. 7 is a front view of the hinge clip on the hinge and screwed into the window frame; and

FIG. 8 is a bottom view of a retaining clip in the shape of a half circle, in which case the hinge will have an indentation in the same shape and size, thereby eliminating any gap so that the window screen fits perfectly in the window frame.

### DETAILED DESCRIPTION

It is known to provide insect screens to cover open windows to allow the circulation of air while preventing the entry of insects. The invention herein provides an inexpensive, attractive and functional alternative to the custom made roll-down type of insect screens, which are quite costly. One advantage of this hinge-type of insect screen assembly is that with side, top and bottom-hinged, outward opening-type windows there is presently no solidly constructed alternative to the expensive custom made roll down type of insect screen. Side, top and bottom-hinged, outward opening-type windows are common in Europe and possibly South America and other places throughout the world. These windows often do not have a crank on the window. Therefore, one must have the ability to open and close the window with one's hand. Also the screen for such windows must be placed on the room side of the window to allow opening and closing of the window without screen removal.

The present invention relates to a hinged window insect screen assembly and a kit for assembling such a screen. The novel screen assembly while being suitable for attachment to a single or double hung window frame, is particularly suitable for a side-hinged or a top and/or bottom-hinged, outward opening-type window frame. The novel screen assembly, when attached to the inside portion of the window frame, permits access for opening and closing of the window by providing a frame which is inwardly foldable in at least about a 90° angle to permit access to open and close the window.

The frame of the novel insect screen assembly is foldable, by means of a hinge, at one or more points along each of two opposing sides. These opposing sides of the insect screen frame, along which the screen itself is foldable.

The novel window screen assembly includes three main parts, the screen member, the screen frame and the hinge assembly. Further the preferred embodiment includes retaining clips for stabilizing the assembly when mounted in a window frame.

The only requirements for the screen is that it be flexible so as to be able to fold at least 90° and that it has a porosity such that most insects cannot get through while allowing air to pass through. The screen may be, for example, a woven mesh, a flexible sheet material having a multiplicity of fine holes therethrough or a non-woven layer. It can be made of virtually any material. For example, it can be metallic, a natural or synthetic fiber, a plastic or polymeric sheet material or fiber, a composite material, carbon fiber or any other material that meets the aforementioned requirements.

The frame for the screen should be rigid or semi rigid and can likewise be formed from any available rigid or semi-rigid material such as metal, polymers, wood, hard rubber or the like. The same is true for the hinge and the retaining clip. Preferably, the retaining clip is made of a semi-rigid material so as to allow enough flexion for the frame to snap into it.

While the embodiments described herein show rectangular window screens for rectangular windows, it should be understood that the present invention is not limited to any specific materials or shapes. For example, it is equally applicable to screens for round or oval windows.

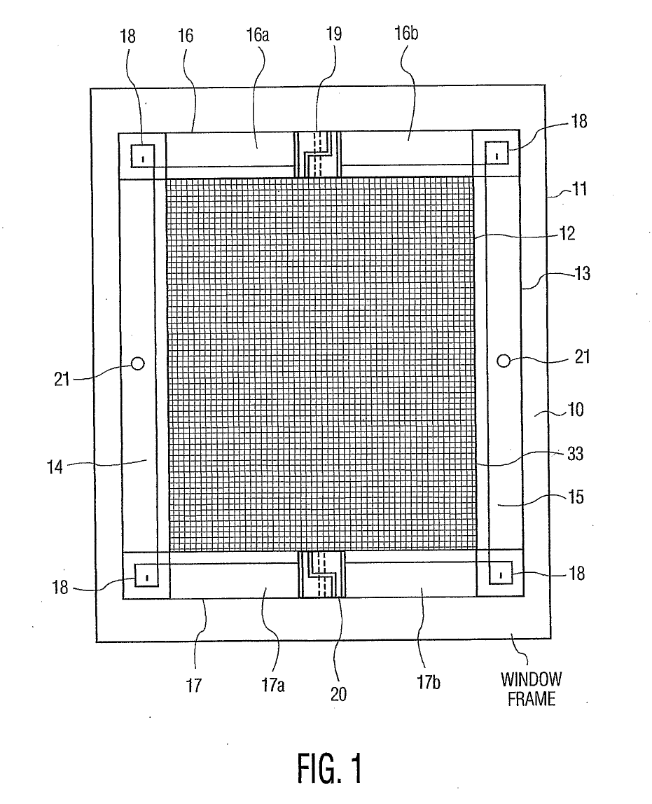

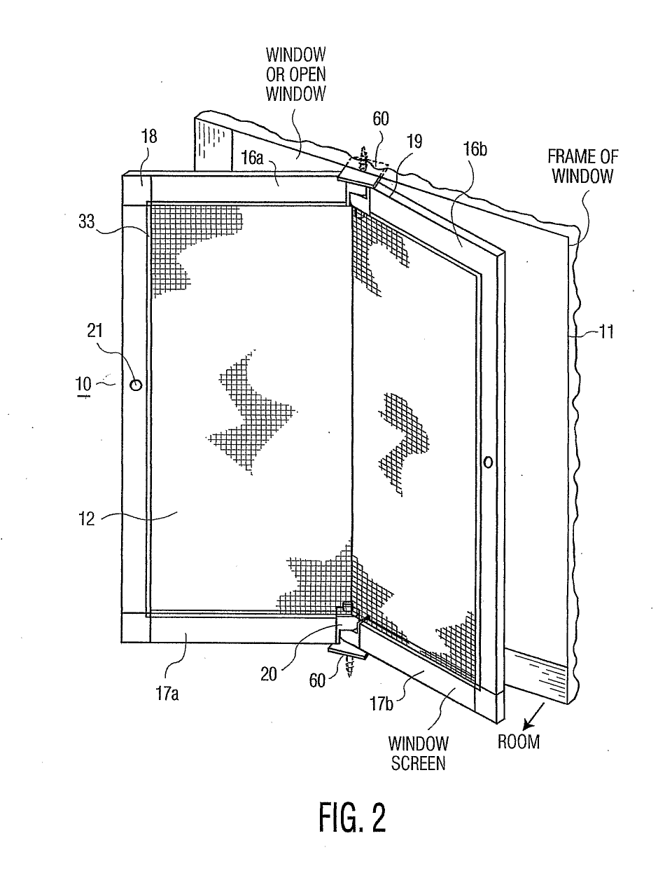

Referring now to FIG. 1, there is shown a window screen assembly 10 in a rectangular window frame 11. The window screen assembly 10 comprises a screen 12 supported in a frame 13. The frame comprises a pair of opposing vertical members 14 and 15 and a pair of opposing horizontal members 16 and 17. The vertical members 14 and 15 are attached to the horizontal members 16 and 17 by corner pieces 18 to form the rectangular frame 11. A novel feature of the present invention is a pair of opposing hinges 19 and 20 in the middle of the horizontal members 16 and 17. The horizontal members 16 and 17 are each split into two halves 16a and 16b, and 17a and 17b respectively, which rotate or pivot around each other by means of the hinges 19 and 20 thereby allowing the horizontal members 16 and 17 and the screen 12 to fold. Preferably, the hinge should allow the assembly to fold at least about 90°. It should be understood that while the embodiment as shown shows only one pair of opposing hinges on the horizontal frame members, the invention includes the presence of a one or more opposing hinge pairs on either or both the horizontal and vertical frame members. As shown in FIG. 2, the hinges are placed so that the screen folds inwardly, i.e. in the direction of the room, around a central vertical axis. Optional handles or knobs 21 are provided for facilitating opening and closing of the screen assembly.

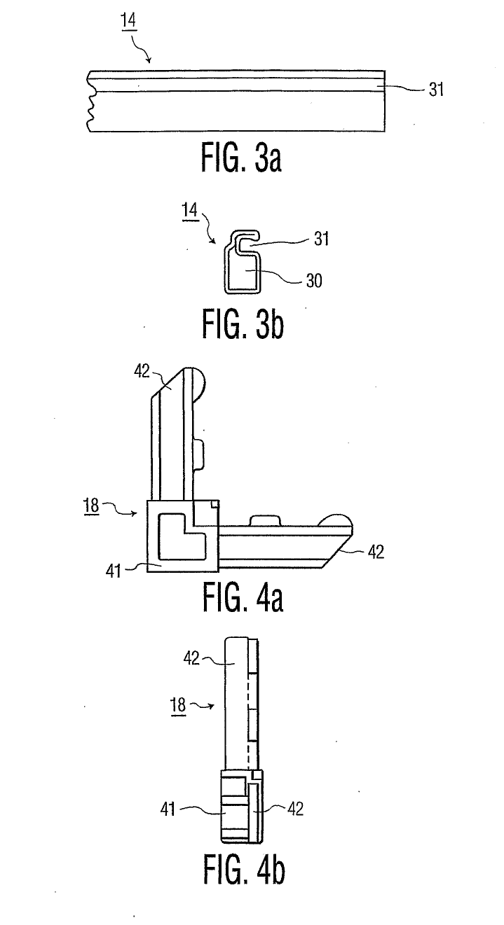

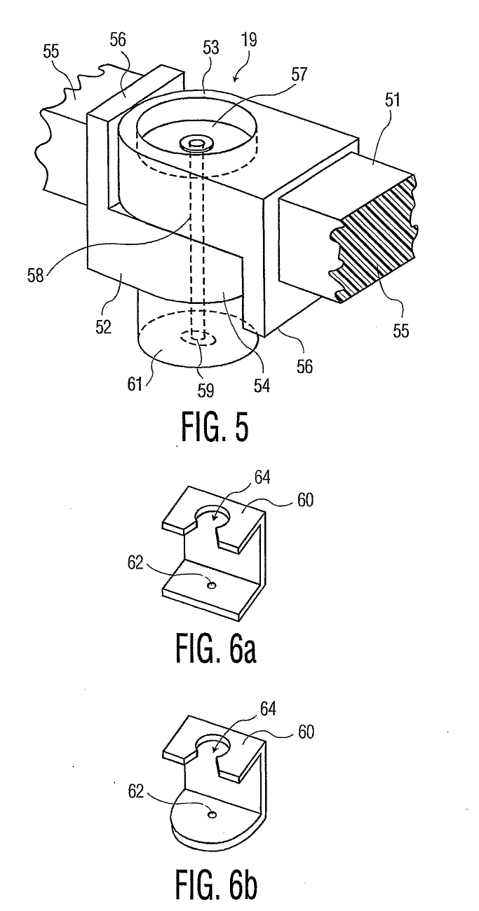

FIGS. 3a and 3b are front and side views respectively, of a preferred screen frame member 14, 15, 16 or 17. The preferred members are formed by folding sheet metal in a manner so as to have a channel 30 through the center thereof and a U-shaped groove 31 along the upper part of its front face 32. The groove 31 is provided to hold the screen material 12 in place by inserting the screen material 12 in the groove 31 and securing it there by then forcing an elastic or rubber strip 33 over the screen 12 and in the groove 31. The channel 30 is provided to allow the insertion of conforming elongated corner arms 42 (FIG. 4) and hinge arms 55 (FIG. 5) therein.

As can be seen with reference to FIGS. 4a and 4b, corner members 18 comprise an exposed square corner section 41 having a pair of corner arms 42 extending therefrom at right angles to each other. The corner arms are shaped to be insertable and snugly fit in the channel 30 of the frame member.

Referring to FIG. 5, there is shown a three dimensional view of the hinge 19. The hinge 19 comprises a top member 51 and a lower member 52. The main central body portions 53 and 54 of the members 51 and 52 respectively, are semicircular and then extend outwardly to form hinge arms 55 and shoulders 56 perpendicular to the hinge arms 55. The hinge arms 55 are snugly insertable into the channel 30 of the frame 16. The top hinge member 51 has a circular depression 57 formed therein to accept the head of a screw used to attach the hinge clip 60 shown in FIG. 6 to the window frame 11. The top and lower members 51 and 52 of the hinge 19 have a centrally aligned hole 58, which defines the hinge rotation axis. A pivot pin 59 is inserted through a bushing 61 and through the hole 58. The hinge rotates 90 degrees around the pivot pin 59. The purpose of the bushing 61 is to provide a surface onto which the hinge clip 60 can be snap onto.

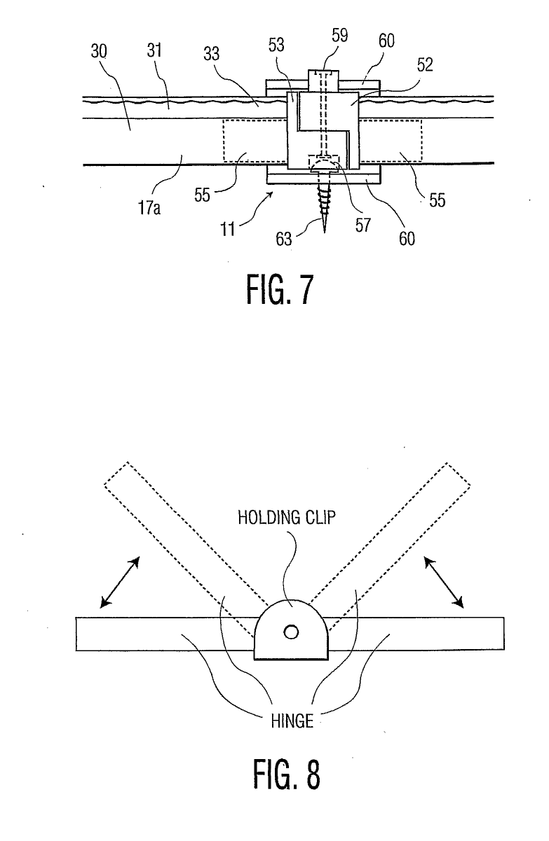

FIG. 6 is a three dimensional view of the hinge clip 60 and FIG. 7 is a front view of the hinge clip 60 on the hinge 19 and screwed into the window frame 11. As can be seen, the hinge clip is substantially a U-shaped member having a small hole 62 through the center of one side of the U for receiving a mounting screw 63. The opposite side of the U has an essentially keyhole shaped opening 64. The clip 60 is first affixed to the window frame by means of screw 63. The assembled window screen 10 is then snapped into the clip 60 by placing the top of the hinge 19 angularly into the clip so that the head of the screw 63 lies within the circular depression 57 and then pressing the hinge bushing 61 into the key-hole shaped opening 64 of the clip 60. Preferably, a hinge clip 60 is provided for each of the hinges 19 and 20. It should be understood that use of a hinge clip or other window screen retaining means for stabilizing the screen assembly is preferred, but not required.

While the invention is described in terms of the preferred embodiment set forth above, it should be understood that the basic invention may vary greatly from the embodiment described above. By way of example, the frame can be fabricated from a variety of materials as previously described and need not have a hollow channel. It may, for example be a solid wooden member wherein the corners are joined by glue, screws, nails, dove-tail joints or any other means commonly employed in woodworking to form a frame. Also, the screen material may be affixed to the frame by any available means including simply gluing it or stapling it to the frame. Further, the hinges can be simple common hinges that are screwed or otherwise mounted to the outer surface of the frame.

The present invention also includes a kit comprising all of the necessary parts for assembling the window screen by the user. For the purposes of a kit, the screen frame can be provided so that it can be cut in any desired length. In this way, a single kit can be used for many different size windows. Preferably, the kit includes a tool for cutting the screen material to the desired size and a tool for cutting the frame to size.

1. A window screen assembly for placement in a window frame comprises a screen member affixed to a screen frame wherein said screen frame has at least one pair of opposing hinges associated therewith whereby rotation of said hinges causes both the screen frame and the screen member to fold.

2. The window screen assembly recited in claim 1, wherein the screen frame comprises a pair of spaced vertical frame members which are attached to a pair of horizontal frame members, each horizontal frame member having two halves coupled together by means of one of said hinges affixed to each of said halves.

3. The window screen assembly recited in claim 2, wherein the hinges are centrally located so that the window screen can open inwardly in the form of a V.

4. The window screen assembly recited in claim 1 further comprising a hinge clip mountable on the window frame and fitting around said hinges in a manner so as to stabilize said screen assembly while allowing folding of said screen assembly about said opposing hinges.

5. The window screen assembly recited in claim 1, wherein the screen frame comprises a pair of spaced horizontal frame members which are attached to a pair of vertical frame members, each vertical frame member having two halves coupled together by means of one of said hinges affixed to each of said halves.

6. The window screen assembly recited in claim 1, wherein the hinges have extended arms and the frame has a channel to receive said arms so as to affix the hinge to the frame members.

7. The window screen assembly recited in claim 6 further including corner pieces, said corner pieces having a square corner section and a pair of orthogonal arms extending therefrom in the same plane and wherein the frame members have a channel at their ends into which said arms are snugly insertable.

8. The window screen assembly recited in claim 4, wherein said hinges include means which snap fit into said hinge clip.

9. A kit for assembling a window screen comprises a roll of screening material, a plurality of screen frame members which can be cut to the desired sizes, screen frame corner pieces, a plurality of hinges, and means for securing the screening material to the screen frame wherein the frame members have a hollow channel therethrough and the corner pieces and hinges have extended arm portions adapted to snugly fit within said hollow channel.

10. The kit recited in claim 9 further comprising a screen frame-cutting tool and a screen material cutting tool.

11. A window screen assembly comprising:
A. a frame assembly constructed for being mounted in a window casement of a building, said frame assembly being dimensioned for insertion and retention in said window casement and comprising a plurality of interconnected support struts, each of said support struts
a. having an elongated longitudinally extending length, and
b. being mounted to an adjacent strut at each terminating end thereof, thereby defining an open zone therebetween;
B. a screen member affixed to the support struts forming the frame assembly and extending between the support struts filling the open zone defined thereby;
C. a first hinge member
a. mounted along the length of a first support strut, and
b. comprising a pair of cooperating components pivotally secured to each other for enabling a first portion of the first support strut to arcuately move relative to a second portion thereof;
D. a second hinge member
a. mounted along the length of a second support strut;
b. comprising a pair of cooperating components pivotally secured to each other for enabling a first portion of the second strut to arcuately move relative to a second portion thereof; and
c. positioned along the second strut in axial alignment with the first hinge member, thereby enabling the first portion of the first strut and the first portion of the second strut to arcuately pivot simultaneously about a common axis.

12. The window screen assembly defined in claim 11, wherein each of said hinge members is further defined as comprising a pair of pivot plates mounted in overlying cooperating relationship with each other for providing arcuate pivoting movement of each plate relative to the other about the same axis with each of said plates incorporating mounting means for enabling each plate to be separately secured to adjacent portions of a support strut.

13. The window screen assembly defined in claim 12, wherein said pivot plates are further defined as being affixed to each other in a vertically stacked array by a single pivot forming pin member.

14. The window screen assembly defined in claim 12, wherein each of said support struts is further defined as comprising an elongated rectangularly shaped, hollow bar incorporating a U-shaped groove formed along one side thereof for receiving and retaining the screen member.

15. The window screen assembly defined in claim 14, and further comprising corner forming clip members constructed for being inserted and securely retained in the hollow zone of two adjacent support struts, thereby inter-connecting two adjacent support struts to each other and securely retaining the support struts in their assembled position.

16. The window screen assembly defined in claim 15, wherein the mounting means of the hinge members are further defined as being dimensioned for insertion and retention in the hollow cavity of the bar forming the support strut to which the hinge member is mounted.

17. The window screen assembly defined in claim 11, wherein the pivot axis defined by the hinge members is defined as comprising one selected from the group consisting of vertical axes formed at any position along the length of the top and bottom support struts and horizontal axis formed at any position along the length of two parallel side formed support struts.

18. The window screen assembly defined in claim 11, and further comprising a plurality of paired hinge member mounted along the length of a support strut in cooperating alignment with an adjacent hinge member for providing a screen assembly having a plurality of pivot axes.
